(19) United States
(12) Patent Application Publication
(10) Pub. No.: US 2019/0059026 A1
(43) Pub. Date: Feb. 21, 2019

(54) Enhancement of voice domain selection in 5GS and fast return from EPS to 5GS

(71) Applicant: MediaTek Inc., Hsinchu City (TW)

(72) Inventors: Chien-Chun Huang-Fu, Hsinchu City (TW); Yu-Syuan Jheng, Hsinchu City (TW); Yuan-Chieh Lin, Hsinchu City (TW)

(21) Appl. No.: 15/998,701

(22) Filed: Aug. 16, 2018

Related U.S. Application Data
(60) Provisional application No. 62/546,034, filed on Aug. 16, 2017.

(51) Int. Cl. H04W 36/00; H04W 48/16

(52) U.S. Cl. CPC H04W 36/0022; H04W 48/16

(57) ABSTRACT

Various examples and schemes pertaining to enhancement of voice domain selection in 5^{th}-Generation Systems (5GS) and fast return from Evolved Packet System (EPS) to 5GS are described. A processor of a user equipment (UE) receive an indication of whether a packet-switched (PS) voice service is supported in a first mobile communication system. The processor performs, based on the indication, voice domain selection (VDS) by selecting and engaging with one of a plurality of mobile communication systems comprising the first mobile communication system and at least a second mobile communication system. The processor performs the VDS before receiving signaling from one of the plurality of communication systems about availability of support for the PS voice service in that mobile communication system.

### CROSS REFERENCE TO RELATED PATENT APPLICATION(S)

The present disclosure is part of a non-provisional application claiming the priority benefit of U.S. Patent Application No. 62/546,034, filed on 16 Aug. 2017, the content of which is incorporated by reference in its entirety.

### TECHNICAL FIELD

The present disclosure is generally related to voice services in mobile communications and, more particularly, to enhancement of voice domain selection in 5^{th}-Generation Systems (5GS) and fast return from Evolved Packet System (EPS) to 5GS.

### BACKGROUND

Unless otherwise indicated herein, approaches described in this section are not prior art to the claims listed below and are not admitted as prior art by inclusion in this section.

Under current specification of 3^{rd}-Generation Partnership Project (3GPP) for Internet Protocol (IP) Multimedia Subsystem (IMS)-supported voice-over-packet-switching (VoPS) services, a voice-centric 5^{th}-Generation Core Network (5GC)-capable user equipment (UE) can determine whether it can obtain voice service in 5GS after receiving network response during a “Registration procedure” (e.g., registration accept or registration reject). However, the specification does not define other scenarios or conditions under which the UE can determine whether it can obtain voice service in 5GS. Accordingly, if voice service is not available in current 5GS situation, the UE needs to reselect an Evolved Universal Mobile Telecommunications System (UMTS) Terrestrial Radio Access Network (E-UTRAN) cell connected to an Evolved Packet Core (EPC) for voice service. Once the UE reselects an EPS due to receipt of an indication of “IMS VoPS not supported” from 5GS, the UE has no chance to go back to 5GS even if 5GS voice is supported in the area in which the UE is currently located. Undesirably, this can result in increased signaling overhead (e.g., due to unnecessary “Registration procedure”).

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure proposes a number of schemes, techniques, methods and apparatus as solutions to address the issues described above.

In one aspect, a method may involve a processor of a user equipment (UE) receiving an indication of whether a packet-switched (PS) voice service is supported in a first mobile communication system. The method may also involve the processor performing, based on the indication, voice domain selection (VDS) by selecting and engaging with one of a plurality of mobile communication systems comprising the first mobile communication system and at least a second mobile communication system. Moreover, the processor may perform the VDS before receiving signaling from one of the plurality of communication systems about availability of support for the PS voice service in that mobile communication system.

In one aspect, a method may involve a processor of a UE transmitting a registration request to a first mobile communication system, with the registration request indicating information related to support of a voice service for the UE. The method may also involve the processor receiving a rejection from the first mobile communication system, with the rejection comprising a cause value of the rejection indicating whether requirement for supporting the voice service in the first mobile communication system is met. The method may further involve the processor initiating a connection with a second mobile communication system responsive to receiving the rejection.

In one aspect, a method may involve a processor of a UE establishing a connection with a second mobile communication system based on VDS. The method may also involve the processor receiving an indication related to support for PS voice service being available in a first mobile communication system. The method may further involve the processor establishing a connection with the first mobile communication system to receive the PS voice service from the first mobile communication system as a result of handover from the second mobile communication system to the first mobile communication system. The method may involve the processor receiving the indication during a fallback procedure by the second mobile communication system, an inter-radio access technology (RAT) handover, an inter-system handover, or a voice call setup procedure.

In one aspect, a method may involve a processor of a UE selecting a second mobile communication system over a first mobile communication system based on a list comprising information stored in the UE related to availability of support for a PS voice service with respect to one or more areas. The method may also involve the processor establishing, at a first point in time, a connection with the second mobile communication system responsive to the selecting. The method may further involve the processor receiving an indication related to the support for the PS voice service being available in the first mobile communication system. The method may additionally involve the processor reselecting, at a second point in time after the first point in time, the first mobile communication system to connect to and receive the PS voice service from the first mobile communication system responsive to the receiving.

It is noteworthy that, although description provided herein may be in the context of certain radio access technologies, networks and network topologies such as 5G, New Radio (NR), Long-Term Evolution (LTE), LTE-Advanced, LTE-Advanced Pro, Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a block diagram of an example communication environment in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sounding reference signal design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

The present disclosure proposes a number of schemes for enhancement of VDS performance, as described below.

Under a first scheme for enhancement of VDS performance in accordance with the present disclosure, a radio access network (RAN) node (e.g., gNB, eNB or transmit/receive point (TRP)) may broadcast an indication of “IMS voice over PS session supported” in system information to indicate to UEs that IMS voice over packet-switched session is supported and, thus, a UE can perform voice domain selection (VDS). For instance, such indication may be provided within a system information block (SIB). Accordingly, a UE can perform VDS before receiving network indication(s) during specific non-access stratum (NAS) procedures (e.g., registration, attach and/or tracking area update (TAU) procedures). Advantageously, this scheme, which provides indication via SIB, may reduce signaling overhead and improve VDS efficiency.

Under the first scheme, in cases in which a network node (e.g., gNB, eNB or TRP) is connected to both EPC and 5GC where supports for IMS voice are different, individual IMS voice support indications for each system (e.g., EPS and 5GS) may be broadcast to inform UEs of the different IMS voice supports/services. For instance, the network node may broadcast different indications such as, for example and without limitation, “EPS IMS VoPS” and “5GS IMS VoPS” to indicate that different IMS voice supports are provided.

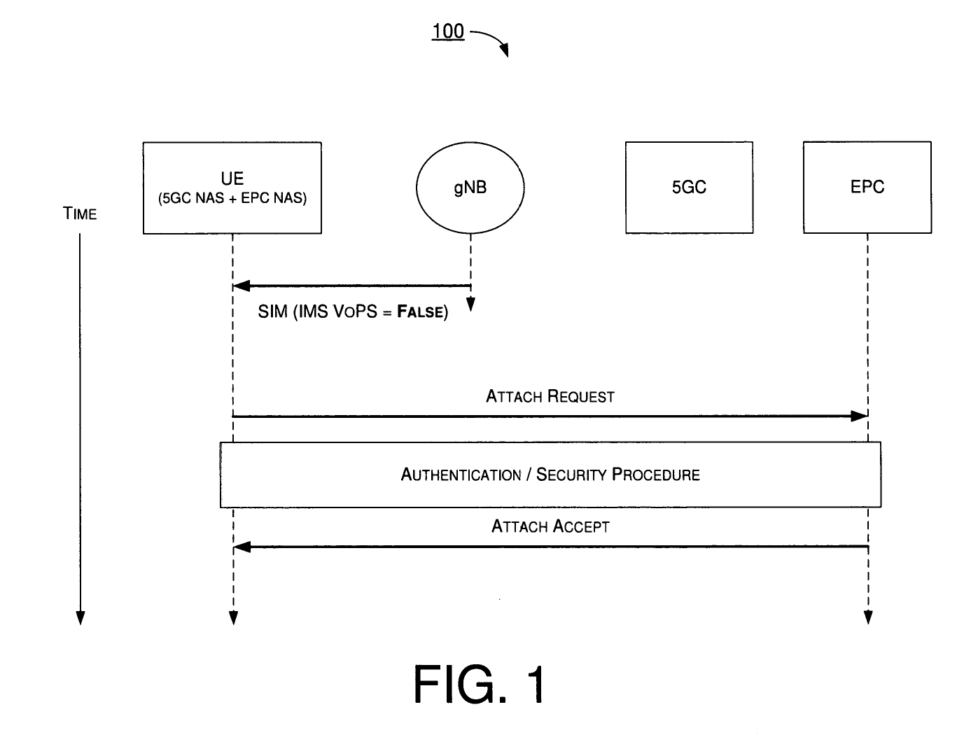

FIG. 1 illustrates an example scenario 100 in accordance with an implementation of the present disclosure. In this example, a UE capable of communications via 5GC NAS and EPC NAS may be in a registration management (RM)-deregistered state. Under the proposed scheme, a network node or base station (represented by a gNB in FIG. 1) connected to a 5GC and an EPC may broadcast a SIB to the UE with the SIB having a “false” value (e.g., 0) in a field for “IMS VoPS” to indicate that IMS VoPS is not supported by the 5GC to which the network node is connected. Upon receiving the SIB with such information, the UE may skip a registration procedure that it would otherwise carry out with the 5GC and, rather, proceed to initiate an EPS Mobility Management (EMM) procedure with the EPC for connection. For instance, the UE may transmit an attach request signal to the EPC and then engage in an authentication and/or security procedure with the EPC. Upon a successful authentication, the EPC may transmit an attach accept signal to the UE to establish a connection with the UE.

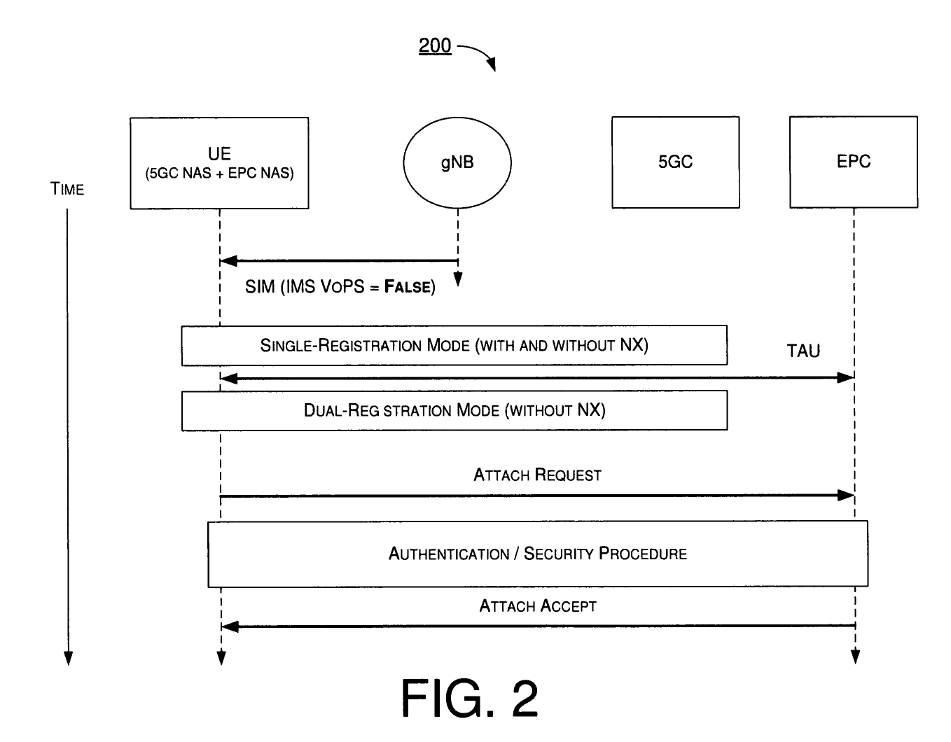

FIG. 2 illustrates an example scenario 200 in accordance with an implementation of the present disclosure. In this example, a UE capable of communications via 5GC NAS and EPC NAS may be in a RM-registered state. Under the proposed scheme, a network node or base station (represented by a gNB in FIG. 2) connected to a 5GC and an EPC may broadcast a SIB to the UE with the SIB having a “false” value (e.g., 0) in a field for “IMS VoPS” to indicate that IMS VoPS is not supported by the 5GC to which the network node is connected. Upon receiving the SIB with such information, the UE may skip a registration procedure that it would otherwise carry out with the 5GC and, rather, proceed to initiate a registration procedure and an authentication and/or security procedure with the EPC for connection. For instance, the UE may transmit a tracking area update (TAU) signal to the EPC. The registration procedure may be performed in either a single-registration mode or a dual-registration mode. Additionally, the UE may transmit an attach request signal to the EPC and then engage in the authentication and/or security procedure with the EPC. Upon a successful authentication, the EPC may transmit an attach accept signal to the UE to establish a connection with the UE.

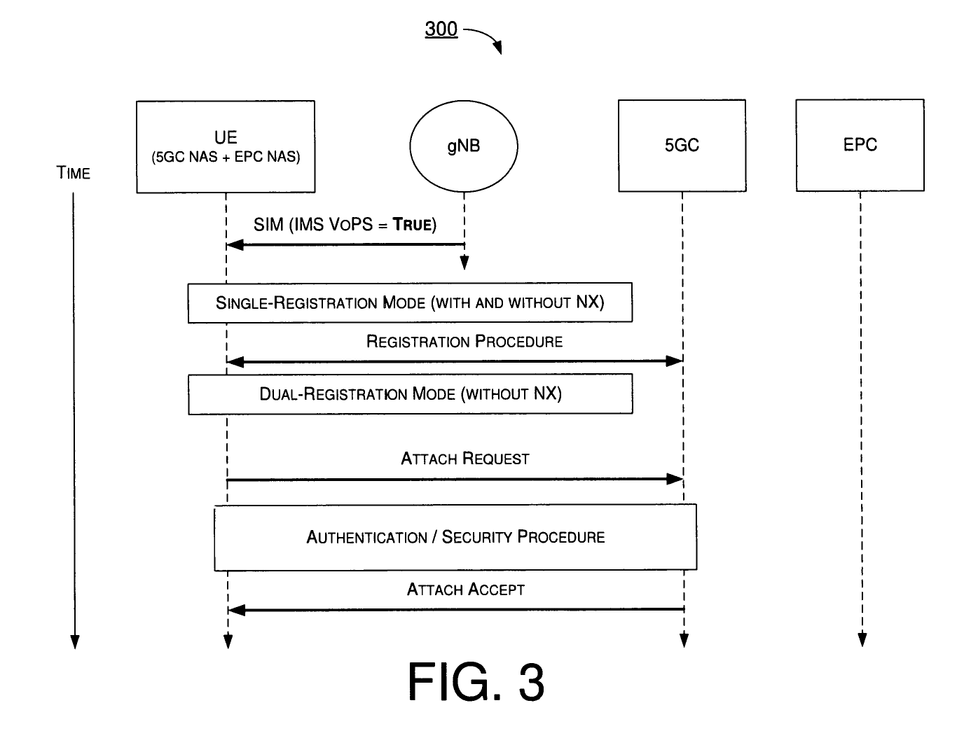

FIG. 3 illustrates an example scenario 300 in accordance with an implementation of the present disclosure. In this example, a UE capable of communications via 5GC NAS and EPC NAS may be in an idle mode. Under the proposed scheme, a network node or base station (represented by a gNB in FIG. 3) connected to a 5GC and an EPC may broadcast a SIB to the UE with the SIB having a “true” value (e.g., 1) in a field for “IMS VoPS” to indicate that IMS VoPS is supported by the 5GC to which the network node is connected. Upon receiving the SIB with such information, the UE may initiate a registration procedure and an EMM procedure with the 5GC for connection. For instance, the UE may transmit a TAU signal to the 5GC. The registration procedure may be performed in either a single-registration mode or a dual-registration mode. Additionally, the UE may transmit an attach request signal to the 5GC and then engage in an authentication and/or security procedure with the 5GC. Upon a successful authentication, the 5GC may transmit an attach accept signal to the UE to establish a connection with the UE.

Under a second scheme for enhancement of VDS performance in accordance with the present disclosure, the network may reject or accept a registration request from a UE with specific cause value to indicate to the UE whether voice support requirement(s) is/are met. Optionally, the network may provide additional information which may include, for example and without limitation, (1) an indication of which area(s) where IMS voice is available and/or unavailable, and/or (2) an indication of homogeneousness (or not) with respect to IMS voice support (e.g., IMS voice service is homogeneously supported). Under the second scheme, the network may indicate availability and unavailability of IMS voice service in different granularities. For instance, the network may indicate that IMS voice service is available or unavailable at a Public Land Mobile Network (PLMN) level, an Access and Mobility Management Function (AMF) level, a registration area (RA) level, and/or a tracking area (TA) level. Moreover, the network may provide additional information on IMS voice support. For instance, the network may indicate that IMS voice service is homogeneously supported, IMS voice service is homogeneously not supported, and/or IMS voice service is non-homogeneously supported. Advantageously, this scheme provides indication via NAS.

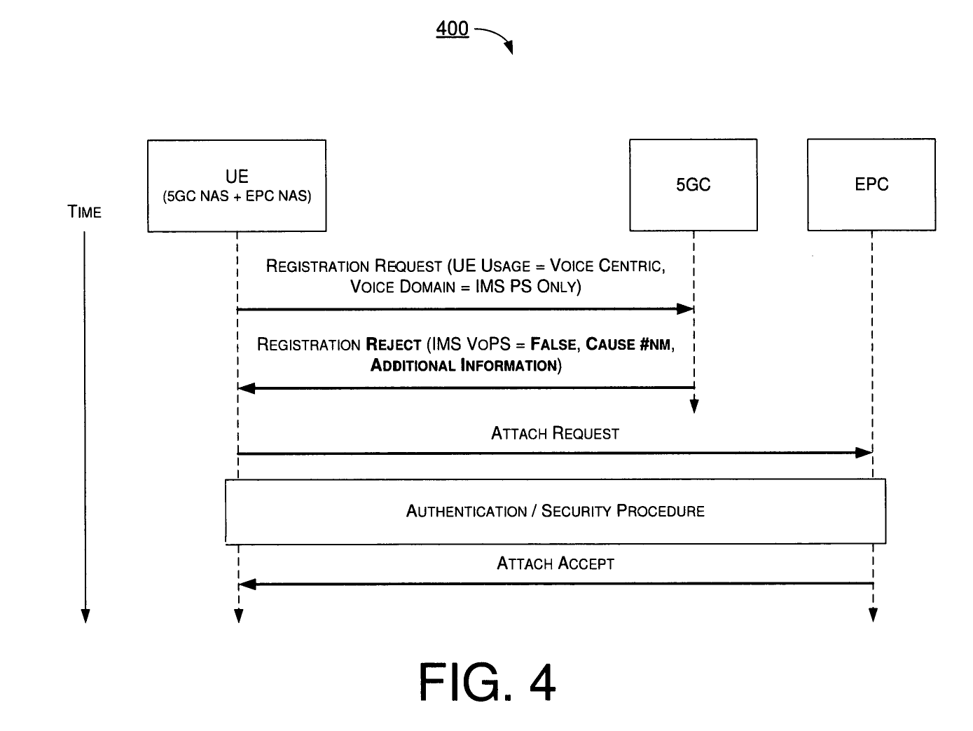

FIG. 4 illustrates an example scenario 400 in accordance with an implementation of the present disclosure. In this example, a UE capable of communications via 5GC NAS and EPC NAS may be in a RM-deregistered state. Under the proposed scheme, the UE may transmit a registration request to a 5GC, with the registration request indicating the UE being voice centric and a voice domain associated with the UE being IMS voice only. In response, the 5GC may transmit a registration reject or rejection to UE. The rejection may include a “false” value (e.g., 0) in a field for “IMS VoPS” to indicate that IMS VoPS is not supported by the 5GC. The rejection may also include a cause value that indicates whether requirement for supporting the voice service in the 5GC is met. Upon receiving the rejection with such information, the UE may proceed to initiate an EMM procedure with the EPC for connection. For instance, the UE may transmit an attach request signal to the EPC and then engage in an authentication and/or security procedure with the EPC. Upon a successful authentication, the EPC may transmit an attach accept signal to the UE to establish a connection with the UE.

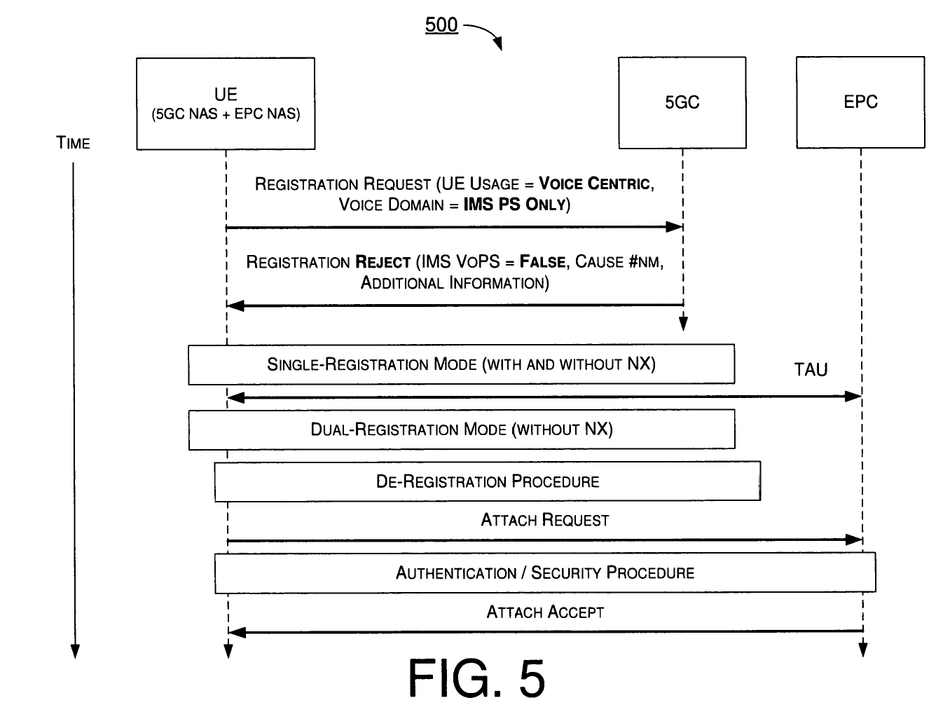

FIG. 5 illustrates an example scenario 500 in accordance with an implementation of the present disclosure. In this example, a UE capable of communications via 5GC NAS and EPC NAS may be in a RM-registered state. Under the proposed scheme, the UE may transmit a registration request to a 5GC, with the registration request indicating the UE being voice centric and a voice domain associated with the UE being IMS voice only. In response, the 5GC may transmit a registration reject or rejection to UE. The rejection may include a “false” value (e.g., 0) in a field for “IMS VoPS” to indicate that IMS VoPS is not supported by the 5GC. The rejection may also include a cause value and additional information. The cause value may indicate whether requirement for supporting the voice service in the 5GC is met. Upon receiving the rejection with such information, the UE may skip a registration procedure that it would otherwise carry out with the 5GC and, rather, proceed to initiate a registration procedure and an authentication and/or security procedure with the EPC for connection. For instance, the UE may transmit a TAU signal to the EPC. The registration procedure may be performed in either a single-registration mode or a dual-registration mode. Additionally, the UE may transmit an attach request signal to the EPC and then engage in the authentication and/or security procedure with the EPC. Upon a successful authentication, the EPC may transmit an attach accept signal to the UE to establish a connection with the UE.

Under a third scheme for enhancement of VDS performance in accordance with the present disclosure, a UE may store information (e.g., as an “IMS voice area list”) about availability/unavailability of IMS voice service for different areas. Granularity of the stored information may be, for example and without limitation, at a PLMN level, an AMF level, an RA level, and/or a TA level. The stored information may also indicate the homogeneousness of IMS voice support (e.g., IMS voice service is homogeneously supported, IMS voice service is homogeneously not supported, and/or IMS voice service is non-homogeneously supported). Accordingly, when the UE performs PLMN/cell selection or reselection subsequently, the stored information (or “IMS voice area list”) may be taken into consideration by the UE, thereby achieving performance enhancement. For instance, based on the stored information, a voice-centric UE may avoid camping on cells and/or TAs where voice service is not supported.

Under the third scheme, there may be a maximum size for the “IMS voice area list”, and each piece of stored information may have an associated validity timer or lifetime. Moreover, each validity timer (or lifetime) of the stored pieces of information may persist across re-boot and change of Universal Subscriber Identity Module (USIM).

The present disclosure also proposes a number of schemes for fast return from EPS to 5GS, as described below.

Under a first scheme for fast return from EPS to 5GS in accordance with the present disclosure, upon PLMN selection procedure, a UE may be able to select or reselect a cell that is connected to 5GC and no other types of networks (e.g., EPC). Under the proposed scheme, the UE may maintain an “IMS voice area list” (e.g., similar or identical to the stored information described above) and utilize this list or stored information in determining whether to select or reselect a cell that is connected to 5GC only. For instance, the UE may store IMS voice service available/unavailable area information (herein referred to as “IMS voice area list”). Granularity of the stored information may be, for example and without limitation, at a PLMN level, an AMF level, an RA level, and/or a TA level. The stored information may also indicate the homogeneousness of IMS voice support (e.g., IMS voice service is homogeneously supported, IMS voice service is homogeneously not supported, and/or IMS voice service is non-homogeneously supported). Accordingly, when the UE performs PLMN/cell selection or reselection subsequently, the stored information (or “IMS voice area list”) may be taken into consideration by the UE, thereby achieving performance enhancement. In other words, the proposed scheme may pertain to UE selection or reselection of cell(s) connected to 5GC only.

Under the proposed scheme, there may be a maximum size for the “IMS voice area list”, and each piece of stored information may have an associated validity timer or lifetime. Moreover, each validity timer (or lifetime) of the stored pieces of information may persist across re-boot and change of USIM.

Under a second scheme for fast return from EPS to 5GS in accordance with the present disclosure, for a 5GC-capable UE to stay in EPS due to VDS, 5GC may provide indication/information to the UE via EPC/E-UTRAN to indicate that the 5GC-capable UE may stay in EPS because of VDS. Under the proposed scheme, the provisioning of indication/information by 5GC may happen during, for example and without limitation, EPS fallback procedure, inter-radio access technology (RAT)/inter-system handover, and/or voice call setup procedure. Upon proper condition, the EPS may redirect or hand over the 5GC-capable UE back to 5GS from EPS. For instance, the EPS may redirect or hand over the 5GC-capable UE back to 5GS after a voice call ended or when voice is supported by 5GS cells in an area where the 5GC-capable UE is located. In other words, the proposed scheme may pertain to network-based quick return to 5GS.

Under a third scheme for fast return from EPS to 5GS in accordance with the present disclosure, for an NR-capable UE to stay in circuit-switched (CS) domain due to VDS (e.g., circuit-switching fallback (CSFB)), EPC may provide indication/information to Global System for Mobile Communications (GSM)/UMTS Core Network or UTRAN/GERAN (GSM/EDGE Radio Access Network) to indicate that the UE is NR-capable and stays in CS domain because of VDS. Under the proposed scheme, the provisioning of indication/information by EPC may during, for example and without limitation, CS fallback procedure, inter-(RAT/inter-system handover, and/or voice call setup procedure. Upon proper condition, a GSM/UMTS system may redirect or hand over the NR-capable UE back to a cell where NR is supported (e.g., either a mater cell or by dual connectivity) from CS domain. For instance, after a voice call ended, the GSM/UMTS system may redirect or hand over the NR-capable UE back to a cell where NR is supported. In other words, the proposed scheme may pertain to network-based quick return to EPS with NR.

### Illustrative Implementations

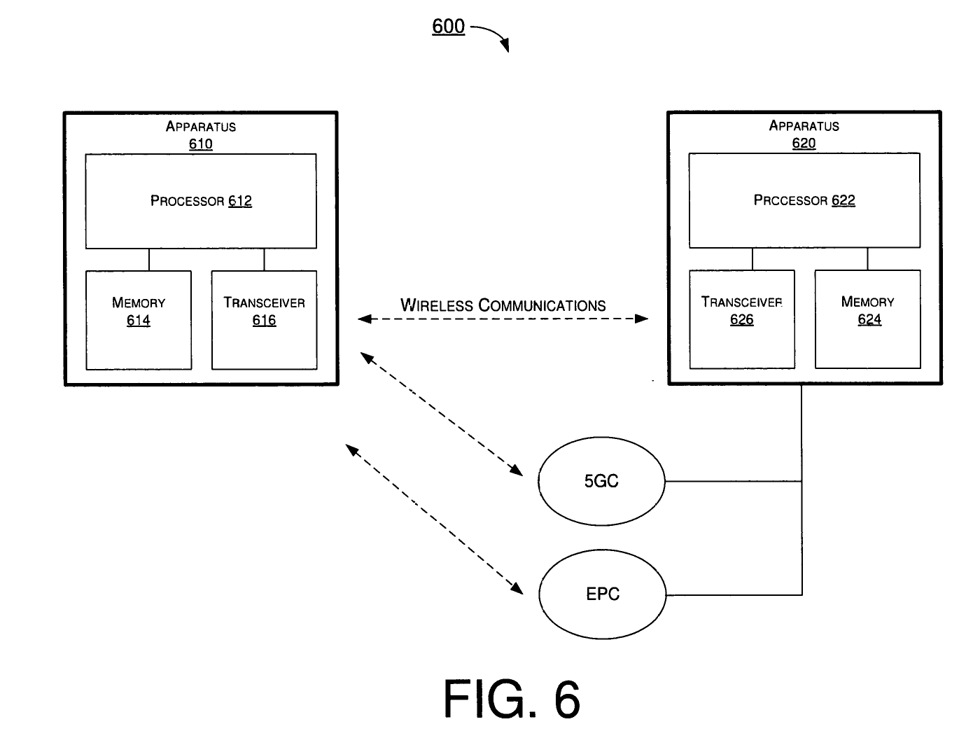

FIG. 6 illustrates an example communication environment 600 having an example apparatus 610 and an example apparatus 620 in accordance with an implementation of the present disclosure. Each of apparatus 610 and apparatus 620 may perform various functions to implement schemes, techniques, processes and methods described herein pertaining to enhancement of voice domain selection in 5GS and fast return from EPS to 5GS in mobile communications, including various schemes described above as well as processes 700, 800, 900 and 1000 described below.

Each of apparatus 610 and apparatus 620 may be a part of an electronic apparatus, which may be a user equipment (UE) such as a portable or mobile apparatus, a wearable apparatus, a wireless communication apparatus or a computing apparatus. For instance, each of apparatus 610 and apparatus 620 may be implemented in a smartphone, a smartwatch, a personal digital assistant, a digital camera, or a computing equipment such as a tablet computer, a laptop computer or a notebook computer. Each of apparatus 610 and apparatus 620 may also be a part of a machine type apparatus, which may be an IoT or NB-IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. Alternatively, each of apparatus 610 and apparatus 620 may be implemented in the form of one or more integrated-circuit (IC) chips such as, for example and without limitation, one or more single-core processors, one or more multi-core processors, or one or more complex-instruction-set-computing (CISC) processors. Each of apparatus 610 and apparatus 620 may include at least some of those components shown in FIG. 6 such as a processor 612 and a processor 622, respectively. Each of apparatus 610 and apparatus 620 may further include one or more other components not pertinent to the proposed scheme of the present disclosure (e.g., internal power supply, display device and/or user interface device), and, thus, such component(s) of each of apparatus 610 and apparatus 620 are neither shown in FIG. 6 nor described below in the interest of simplicity and brevity.

In some implementations, at least one of apparatus 610 and apparatus 620 may be a part of an electronic apparatus, which may be a network node such as a transmit/receive point (TRP), a base station, a small cell, a router or a gateway. For instance, at least one of apparatus 610 and apparatus 620 may be implemented in an eNodeB in an LTE, LTE-Advanced or LTE-Advanced Pro network or in a gNB in a 5G, NR, IoT or NB-IoT network. Alternatively, at least one of apparatus 610 and apparatus 620 may be implemented in the form of one or more IC chips such as, for example and without limitation, one or more single-core processors, one or more multi-core processors, or one or more CISC processors.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including enhancement of voice domain selection in 5GS and fast return from EPS to 5GS in accordance with various implementations of the present disclosure.

In some implementations, apparatus 610 may also include a transceiver 616 coupled to processor 612 and capable of wirelessly transmitting and receiving data. In some implementations, apparatus 610 may further include a memory 614 coupled to processor 612 and capable of being accessed by processor 612 and storing data therein. In some implementations, apparatus 620 may also include a transceiver 626 coupled to processor 622 and capable of wirelessly transmitting and receiving data. In some implementations, apparatus 620 may further include a memory 624 coupled to processor 622 and capable of being accessed by processor 622 and storing data therein. Accordingly, apparatus 610 and apparatus 620 may wirelessly communicate with each other via transceiver 616 and transceiver 626, respectively.

To aid better understanding, the following description of the operations, functionalities and capabilities of each of apparatus 610 and apparatus 620 is provided in the context of a mobile communication environment in which apparatus 610 is implemented in or as a wireless communication device, a communication apparatus or a UE and apparatus 620 is implemented in or as a network node (e.g., base station) connected or otherwise communicatively coupled to both a 5GC of a 5GS and an EPC of an EPS.

With respect to enhancement of voice domain selection in 5GS in accordance with the present disclosure, processor 612 of apparatus 610 may receive, via transceiver 616, an indication of whether a packet-switched (PS) voice service is supported in a first mobile communication system. Moreover, processor 612 may perform, based on the indication, voice domain selection (VDS) by selecting and engaging with one of a plurality of mobile communication systems comprising the first mobile communication system and at least a second mobile communication system in which the PS voice service is supported. In some implementation, in performing the selecting and engaging, processor 612 may perform the VDS before receiving signaling (e.g., NAS signaling or SIB signaling) from one of the plurality of communication systems about availability of support for the PS voice service in that mobile communication system. That is, because of the indication, processor 612 may become aware that support for PS voice service in the first mobile communication system (e.g., 5GS) is not available at the time. Thus, processor 612 may select and connect to another mobile communication system (e.g., EPS or UMTS) without knowing beforehand whether support for PS voice service is available in such mobile communication system.

In some implementations, in engaging, processor 612 may initiate a connection with the second mobile communication system responsive to the indication indicating that the PS voice service is not supported in the first mobile communication system.

In some implementations, in receiving the indication, processor 612 may receive the indication in a system information block (SIB) or via NAS from a network node (e.g., apparatus 620) which is connected to both the first mobile communication system and the second mobile communication system.

In some implementations, in receiving the indication, processor 612 may receive the indication after a voice call provided by the second mobile communication system for apparatus 610 ends or upon availability of the support for the PS voice service in the first mobile communication system.

In some implementations, the indication may include information on availability of the support for the PS voice service with respect to one or more areas. In some implementations, the indication may further include information on homogeneousness of support of the PS voice service with respect to the one or more areas. In some implementations, a granularity of the availability of the support for the PS voice service with respect to the one or more areas as indicated by the information is at a Public Land Mobile Network (PLMN) level, an Access and Mobility Management Function (AMF) level, a registration area (RA) level, or a tracking area (TA) level.

In some implementations, the first mobile communication system may include a 5GS, the second mobile communication system may include an EPS or a Universal Mobile Telecommunications System (UMTS), and the PS voice service may include an IMS-supported voice service. In some implementations, the indication may indicate that the PS voice service is not supported in the first mobile communication system. Moreover, in engaging, processor 612 may execute a registration procedure with the second mobile communication system in either a single-registration mode or a dual-registration mode with the UE in a registered state with respect to registration management. In some implementations, processor 612 may further perform other operations. For instance, processor 612 may receive, via transceiver 616, another indication that the PS voice service is supported in the first mobile communication system. Furthermore, processor 612 may execute a registration procedure with the first mobile communication system.

In some implementations, processor 612 may store information on availability of the support for the PS voice service with respect to one or more areas in a list. Moreover, processor 612 may perform selection of a Public Land Mobile Network (PLMN) or a cell based on the list. In some implementations, a size of the list may be limited to a predefined maximum size, and each piece of information stored in the list may have a corresponding lifetime that persists across re-boot and change of Universal Subscriber Identity Module (USIM).

In some implementations, the list may further include information on homogeneousness of support of the PS voice service with respect to the one or more areas. In some implementations, a granularity of the availability of the support for the PS voice service with respect to the one or more areas as stored in the list is at a PLMN level, an AMF level, an RA level, or a TA level.

In some implementations, processor 612 may transmit, via transceiver 616, a registration request to a first mobile communication system. The registration request may indicate information related to support of a voice service for the UE. Additionally, processor 612 may receive, via transceiver 616, a rejection from the first mobile communication system. The rejection may include a cause value of the rejection indicating whether requirement for supporting the voice service in the first mobile communication system is met. Moreover, processor 612 may initiate a connection with a second mobile communication system responsive to receiving the rejection.

In some implementations, the indication may include information on availability of support for the PS voice service with respect to one or more areas. In some implementations, the indication may further include information on homogeneousness of support of the PS voice service with respect to the one or more areas. In some implementations, a granularity of the availability of the support for the PS voice service with respect to the one or more areas as indicated by the information may be at a PLMN level, an AMF level, an RA level, or a TA level.

In some implementations, the first mobile communication system may include a 5GS, the second mobile communication system may include an EPS, and the PS voice service may include an IMS-supported voice service.

In some implementations, processor 612 may execute a registration procedure with the second mobile communication system in either a single-registration mode or a dual-registration mode with the UE in a registered state with respect to registration management.

With respect to fast return from EPS to 5GS in accordance with the present disclosure, processor 612 may select a second mobile communication system over a first mobile communication system based on a list comprising information stored in the UE related to availability of support for a PS voice service with respect to one or more areas. Additionally, processor 612 may establish, at a first point in time, a connection with the second mobile communication system responsive to the selecting. Moreover, processor 612 may receive, via transceiver 616, an indication related to the support for the PS voice service being available in the first mobile communication system. Furthermore, processor 612 may reselect, at a second point in time after the first point in time, the first mobile communication system to connect to and receive the PS voice service from the first mobile communication system responsive to the receiving

In some implementations, in receiving the indication, processor 612 may receive the indication after a voice call provided by the second mobile communication system for apparatus 610 ends or upon availability of the support for the PS voice service in the first mobile communication system.

In some implementations, in receiving the indication, processor 612 may receive the indication from the second mobile communication system or a network node (e.g., apparatus 620) connected to both the first mobile communication system and the second mobile communication system. In some implementations, the first mobile communication system may include a 5GS, the second mobile communication system may include an EPS, and the PS voice service may include an IMS-supported voice service.

In some implementations, a size of the list may be limited to a predefined maximum size. In some implementations, the list may further include information on homogeneousness of support of the PS voice service with respect to the one or more areas. In some implementations, a granularity of the availability of the support for the PS voice service with respect to the one or more areas as stored in the list may be at a PLMN level, an AMF level, an RA level, or a TA level. In some implementations, each piece of information stored in the list may have a corresponding lifetime that persists across re-boot and change of USIM.

With respect to fast return from EPS to 5GS in accordance with the present disclosure, processor 612 may establish a connection with a second mobile communication system based on VDS. Moreover, processor 612 may receive, via transceiver 616, an indication related to support for PS voice service being available in a first mobile communication system. For instance, processor 612 may receive the indication in a system information block (SIB) or via NAS during a fallback procedure by the second mobile communication system, an inter-radio access technology (RAT) handover, an inter-system handover, or a voice call setup procedure. Furthermore, processor 612 may establish a connection with the first mobile communication system to receive the PS voice service from the first mobile communication system as a result of handover from the second mobile communication system to the first mobile communication system based on the indication. For instance, processor 612 may establish the connection with the first mobile communication system based on the indication and a usage setting of the UE.

In some implementations, in receiving the indication, processor 612 may receive the indication after a voice call provided by the second mobile communication system for the UE ends or upon availability of the support for the PS voice service in the first mobile communication system.

In some implementations, the first mobile communication system may include a 5GS, and the second mobile communication system may include an EPS or a UMTS. Moreover, the PS voice service may include an IMS-supported voice service.

In some implementations, in establishing the connection with the second mobile communication system, processor 612 may select the second mobile communication system based on a list comprising information stored in memory 614 of apparatus 610 related to availability of support for a PS voice service with respect to one or more areas.

In some implementations, the indication may also include information on homogeneousness of support of the PS voice service with respect to the one or more areas. In some implementations, a granularity of the availability of the support for the PS voice service with respect to the one or more areas as stored in the list may be at a PLMN level, an AMF level, an RA level, or a TA level.

### Illustrative Processes

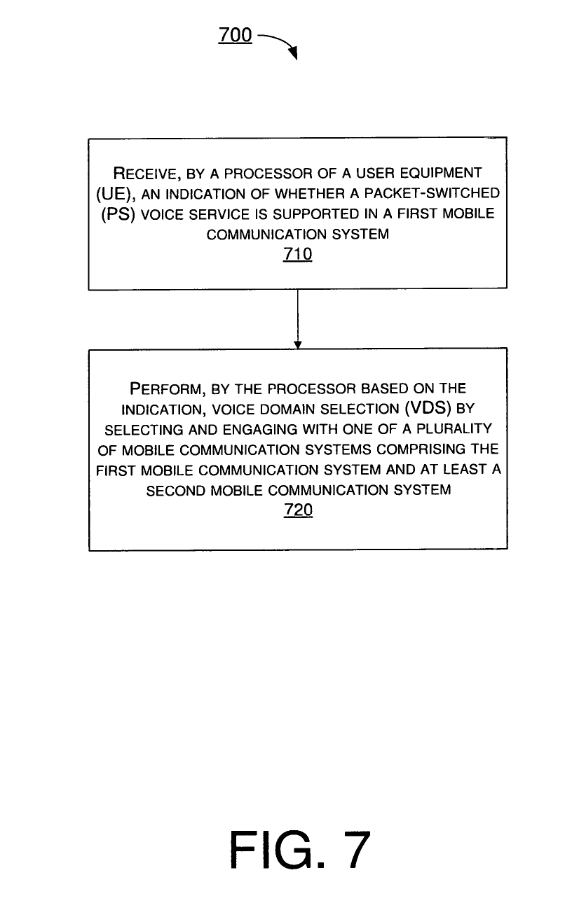

FIG. 7 illustrates an example process 700 in accordance with an implementation of the present disclosure. Process 700 may be an example implementation of the proposed schemes described above with respect to enhancement of voice domain selection in 5GS in accordance with the present disclosure. Process 700 may represent an aspect of implementation of features of apparatus 610 and apparatus 620. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 610, apparatus 620 and/or any suitable wireless communication device, UE, base station or machine type devices. Solely for illustrative purposes and without limitation, process 700 is described below in the context of apparatus 610. Process 700 may begin at block 710.

At 710, process 700 may involve processor 612 of apparatus 610 receiving, via transceiver 616, an indication of whether a packet-switched (PS) voice service is supported in a first mobile communication system. Process 700 may proceed from 710 to 720.

At 720, process 700 may involve processor 612 performing, based on the indication, voice domain selection (VDS) by selecting and engaging with one of a plurality of mobile communication systems comprising the first mobile communication system and at least a second mobile communication system.

In some implementation, in performing the selecting and engaging, process 700 may involve processor 612 performing the VDS before receiving signaling (e.g., NAS signaling or SIB signaling) from one of the plurality of communication systems about availability of support for the PS voice service in that mobile communication system.

In some implementations, in engaging, process 700 may involve processor 612 initiating a connection with the second mobile communication system responsive to the indication indicating that the PS voice service is not supported in the first mobile communication system.

In some implementations, in receiving the indication, process 700 may involve processor 612 receiving the indication in a system information block (SIB) or via NAS from a network node (e.g., apparatus 620) which is connected to both the first mobile communication system and the second mobile communication system.

In some implementations, in receiving the indication, process 700 may involve processor 612 receiving the indication after a voice call provided by the second mobile communication system for the UE ends or upon availability of the support for the PS voice service in the first mobile communication system.

In some implementations, the indication may include information on availability of the support for the PS voice service with respect to one or more areas. In some implementations, the indication may further include information on homogeneousness of support of the PS voice service with respect to the one or more areas. In some implementations, a granularity of the availability of the support for the PS voice service with respect to the one or more areas as indicated by the information is at a Public Land Mobile Network (PLMN) level, an Access and Mobility Management Function (AMF) level, a registration area (RA) level, or a tracking area (TA) level.

In some implementations, the first mobile communication system may include a 5GS, the second mobile communication system may include an EPS or a UMTS, and the PS voice service may include an IMS-supported voice service. In some implementations, the indication may indicate that the PS voice service is not supported in the first mobile communication system. Moreover, in engaging, process 700 may further involve processor 612 executing a registration procedure with the second mobile communication system in either a single-registration mode or a dual-registration mode with the UE in a registered state with respect to registration management. In some implementations, process 700 may also involve processor 612 performing other operations. For instance, process 700 may involve processor 612 receiving another indication that the PS voice service is supported in the first mobile communication system. Furthermore, process 700 may involve processor 612 executing a registration procedure with the first mobile communication system.

In some implementations, process 700 may further involve processor 612 performing additional operations. For instance, process 700 may involve processor 612 storing information on availability of the support for the PS voice service with respect to one or more areas in a list. Moreover, process 700 may involve processor 612 performing selection of a Public Land Mobile Network (PLMN) or a cell based on the list. In some implementations, a size of the list may be limited to a predefined maximum size, and each piece of information stored in the list may have a corresponding lifetime that persists across re-boot and change of Universal Subscriber Identity Module (USIM).

In some implementations, the list may further include information on homogeneousness of support of the PS voice service with respect to the one or more areas. In some implementations, a granularity of the availability of the support for the PS voice service with respect to the one or more areas as stored in the list is at a PLMN level, an AMF level, an RA level, or a TA level.

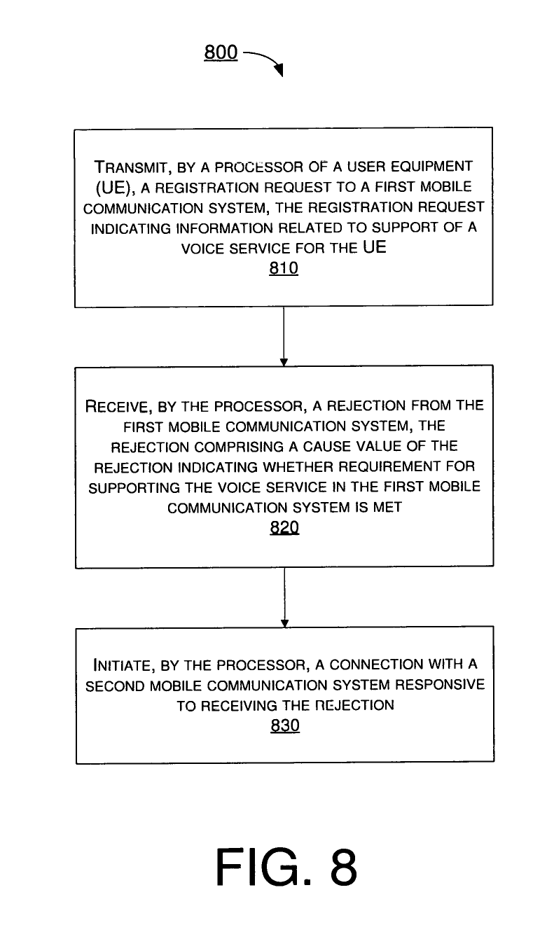

FIG. 8 illustrates an example process 800 in accordance with an implementation of the present disclosure. Process 800 may be an example implementation of the proposed schemes described above with respect to enhancement of voice domain selection in 5GS in accordance with the present disclosure. Process 800 may represent an aspect of implementation of features of apparatus 610 and apparatus 620. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may also be repeated partially or entirely. Process 800 may be implemented by apparatus 610, apparatus 620 and/or any suitable wireless communication device, UE, base station or machine type devices. Solely for illustrative purposes and without limitation, process 800 is described below in the context of apparatus 610. Process 800 may begin at block 810.

At 810, process 800 may involve processor 612 of apparatus 610 transmitting a registration request to a first mobile communication system. The registration request may indicate information related to support of a voice service for the UE. Process 800 may proceed from 810 to 820.

At 820, process 800 may involve processor 612 receiving a rejection from the first mobile communication system. The rejection may include a cause value of the rejection indicating whether requirement for supporting the voice service in the first mobile communication system is met. Process 800 may proceed from 820 to 830.

At 830, process 800 may involve processor 612 initiating a connection with a second mobile communication system responsive to receiving the rejection.

In some implementations, the indication may include information on availability of support for the PS voice service with respect to one or more areas. In some implementations, the indication may further include information on homogeneousness of support of the PS voice service with respect to the one or more areas. In some implementations, a granularity of the availability of the support for the PS voice service with respect to the one or more areas as indicated by the information may be at a PLMN level, an AMF level, an RA level, or a TA level.

In some implementations, the first mobile communication system may include a 5GS, the second mobile communication system may include an EPS or a UMTS, and the PS voice service may include an IMS-supported voice service.

In some implementations, process 800 may further involve processor 612 executing a registration procedure with the second mobile communication system in either a single-registration mode or a dual-registration mode with the UE in a registered state with respect to registration management.

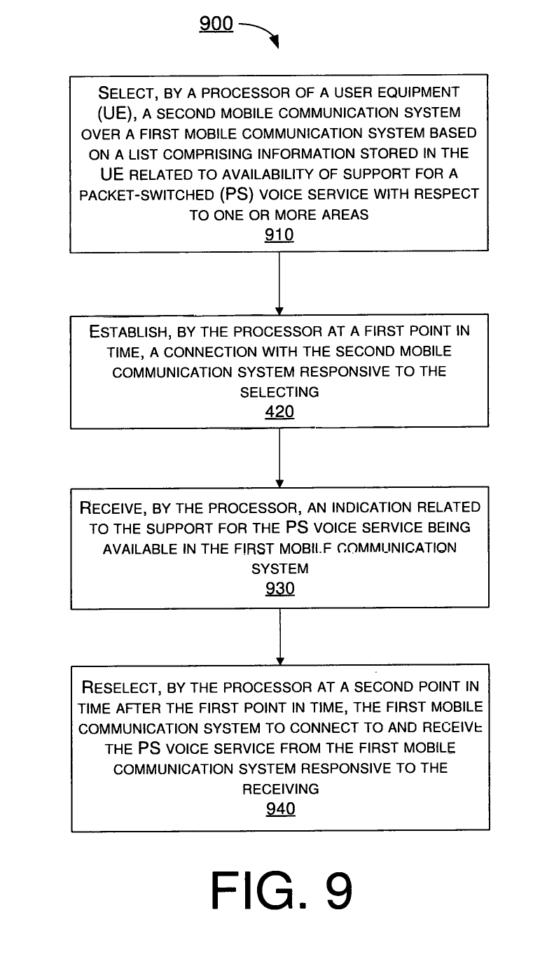

FIG. 9 illustrates an example process 900 in accordance with an implementation of the present disclosure. Process 900 may be an example implementation of the proposed schemes described above with respect to fast return from EPS to 5GS in accordance with the present disclosure. Process 900 may represent an aspect of implementation of features of apparatus 610 and apparatus 620. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may also be repeated partially or entirely. Process 900 may be implemented by apparatus 610, apparatus 620 and/or any suitable wireless communication device, UE, base station or machine type devices. Solely for illustrative purposes and without limitation, process 900 is described below in the context of apparatus 610. Process 900 may begin at block 910.

At 910, process 900 may involve processor 612 of apparatus 610 selecting a second mobile communication system over a first mobile communication system based on a list comprising information stored in the UE related to availability of support for a PS voice service with respect to one or more areas. Process 900 may proceed from 910 to 920.

At 920, process 900 may involve processor 612 establishing, at a first point in time, a connection with the second mobile communication system responsive to the selecting. Process 900 may proceed from 920 to 930.

At 930, process 900 may involve processor 612 receiving an indication related to the support for the PS voice service being available in the first mobile communication system. Process 900 may proceed from 930 to 940.

At 940, process 900 may involve processor 612 reselecting, at a second point in time after the first point in time, the first mobile communication system to connect to and receive the PS voice service from the first mobile communication system responsive to the receiving

In some implementations, in receiving the indication, process 900 may involve processor 612 receiving the indication after a voice call provided by the second mobile communication system for apparatus 610 ends or upon availability of the support for the PS voice service in the first mobile communication system.

In some implementations, in receiving the indication, process 900 may involve processor 612 receiving the indication from the second mobile communication system or a network node (e.g., apparatus 620) connected to both the first mobile communication system and the second mobile communication system. In some implementations, the first mobile communication system may include a 5GS, the second mobile communication system may include an EPS, and the PS voice service may include an IMS-supported voice service.

In some implementations, a size of the list may be limited to a predefined maximum size. In some implementations, the list may further include information on homogeneousness of support of the PS voice service with respect to the one or more areas. In some implementations, a granularity of the availability of the support for the PS voice service with respect to the one or more areas as stored in the list may be at a PLMN level, an AMF level, an RA level, or a TA level. In some implementations, each piece of information stored in the list may have a corresponding lifetime that persists across re-boot and change of USIM.

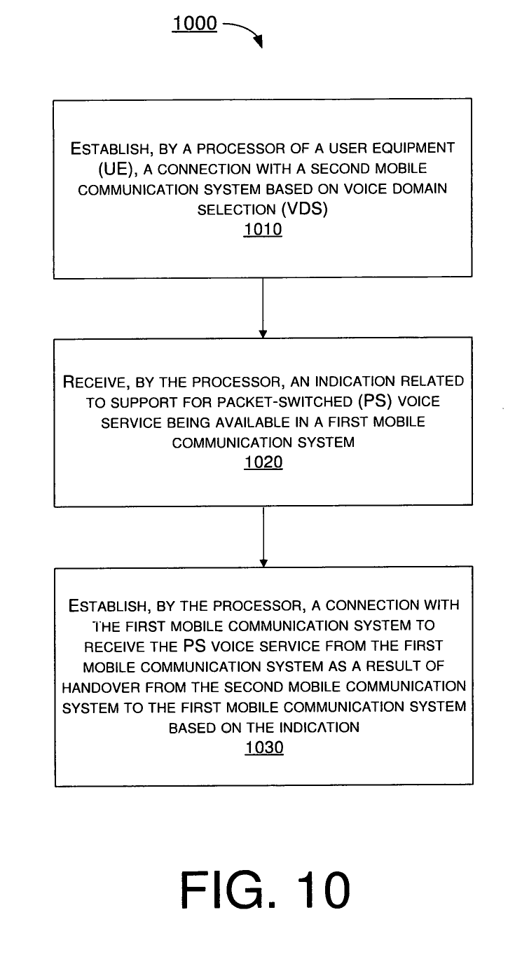

FIG. 10 illustrates an example process 1000 in accordance with an implementation of the present disclosure. Process 1000 may be an example implementation of the proposed schemes described above with respect to fast return from EPS to 5GS in accordance with the present disclosure. Process 1000 may represent an aspect of implementation of features of apparatus 610 and apparatus 620. Process 1000 may include one or more operations, actions, or functions as illustrated by one or more of blocks 1010, 1020, 1030 and 1040. Although illustrated as discrete blocks, various blocks of process 1000 may be divided into additional blocks, combined into fewer blocks, or eliminated, depending on the desired implementation. Moreover, the blocks of process 1000 may executed in the order shown in FIG. 10 or, alternatively, in a different order. Process 1000 may also be repeated partially or entirely. Process 1000 may be implemented by apparatus 610, apparatus 620 and/or any suitable wireless communication device, UE, base station or machine type devices. Solely for illustrative purposes and without limitation, process 1000 is described below in the context of apparatus 610. Process 1000 may begin at block 1010.

At 1010, process 1000 may involve processor 612 of apparatus 610 establishing a connection with a second mobile communication system based on VDS. Process 1000 may proceed from 1010 to 1020.

At 1020, process 1000 may involve processor 612 receiving, via transceiver 616, an indication related to support for PS voice service being available in a first mobile communication system. For instance, process 1000 may involve processor 612 receiving the indication in a system information block (SIB) or via NAS during a fallback procedure by the second mobile communication system, an inter-radio access technology (RAT) handover, an inter-system handover, or a voice call setup procedure. Process 1000 may proceed from 1020 to 1030.

At 1030, process 1000 may involve processor 612 establishing a connection with the first mobile communication system to receive the PS voice service from the first mobile communication system as a result of handover from the second mobile communication system to the first mobile communication system based on the indication. For instance, processor 612 may establish the connection with the first mobile communication system based on the indication and a usage setting of the UE.

In some implementations, in receiving the indication, process 1000 may involve processor 612 receiving the indication after a voice call provided by the second mobile communication system for the UE ends or upon availability of the support for the PS voice service in the first mobile communication system.

In some implementations, the first mobile communication system may include a 5GS, and the second mobile communication system may include an EPS or a UMTS. Moreover, the PS voice service may include an IMS-supported voice service.

In some implementations, in establishing the connection with the second mobile communication system, process 1000 may involve processor 612 selecting the second mobile communication system based on a list comprising information stored in memory 614 of apparatus 610 related to availability of support for a PS voice service with respect to one or more areas.

In some implementations, the indication may also include information on homogeneousness of support of the PS voice service with respect to the one or more areas. In some implementations, a granularity of the availability of the support for the PS voice service with respect to the one or more areas as stored in the list may be at a PLMN level, an AMF level, an RA level, or a TA level.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), an indication of whether a packet-switched (PS) voice service is supported in a first mobile communication system; and
performing, by the processor based on the indication, voice domain selection (VDS) by selecting and engaging with one of a plurality of mobile communication systems comprising the first mobile communication system and at least a second mobile communication system,
wherein the processor performs the VDS before receiving signaling from one of the plurality of communication systems about availability of support for the PS voice service in that mobile communication system.

2. The method of claim 1, wherein the engaging comprises initiating a connection with the second mobile communication system or another mobile communication system of the plurality of mobile communication systems responsive to the indication indicating that the PS voice service is not supported in the first mobile communication system.

3. The method of claim 1, wherein the receiving of the indication comprises receiving the indication in a system information block (SIB) or via NAS from a network node which is connected to either the first mobile communication system or the second mobile communication system, or both.

4. The method of claim 1, wherein the receiving of the indication comprises receiving the indication after a voice call provided by the second mobile communication system for the UE ends or upon availability of the support for the PS voice service in the first mobile communication system.

5. The method of claim 1, wherein the indication comprises information on availability of the support for the PS voice service with respect to one or more areas, and wherein the indication further comprises information on homogeneousness of support of the PS voice service with respect to the one or more areas.

6. The method of claim 5, wherein a granularity of the availability of the support for the PS voice service with respect to the one or more areas as indicated by the information is at a Public Land Mobile Network (PLMN) level, an Access and Mobility Management Function (AMF) level, a registration area (RA) level, or a tracking area (TA) level.

7. The method of claim 1, wherein the first mobile communication system comprises a 5^{th}-Generation System (5GS), wherein the second mobile communication system comprises an Evolved Packet System (EPS) or a Universal Mobile Telecommunications System (UMTS), and wherein the PS voice service comprises an Internet Protocol (IP) Multimedia Subsystem (IMS)-supported voice service.

8. The method of claim 7, wherein the indication indicates that the PS voice service is not supported in the first mobile communication system, and wherein the engaging further comprises executing a registration procedure with the second mobile communication system in either a single-registration mode or a dual-registration mode with the UE in a registered state with respect to registration management.

9. The method of claim 8, further comprising:
receiving, by the processor, another indication that the PS voice service is supported in the first mobile communication system; and
executing, by the processor, a registration procedure with the first mobile communication system.

10. The method of claim 1, further comprising:
storing, by the processor, information on availability of the support for the PS voice service with respect to one or more areas in a list; and
performing, by the processor, selection of a Public Land Mobile Network (PLMN) or a cell based on the list.

11. The method of claim 10, wherein a size of the list is limited to a predefined maximum size, and wherein each piece of information stored in the list has a corresponding lifetime that persists across re-boot and change of Universal Subscriber Identity Module (USIM).

12. The method of claim 10, wherein the list further comprises information on homogeneousness of support of the PS voice service with respect to the one or more areas.

13. The method of claim 10, wherein a granularity of the availability of the support for the PS voice service with respect to the one or more areas as stored in the list is at a PLMN level, an Access and Mobility Management Function (AMF) level, a registration area (RA) level, or a tracking area (TA) level.

14. A method, comprising:
transmitting, by a processor of a user equipment (UE), a registration request to a first mobile communication system, the registration request indicating information related to support of a voice service for the UE;
receiving, by the processor, a rejection from the first mobile communication system, the rejection comprising a cause value of the rejection indicating whether requirement for supporting the voice service in the first mobile communication system is met; and
initiating, by the processor, a connection with a second mobile communication system responsive to receiving the rejection.

15. The method of claim 14, wherein the indication comprises information on availability of support for the PS voice service with respect to one or more areas, wherein the indication further comprises information on homogeneousness of support of the PS voice service with respect to the one or more areas, and wherein a granularity of the availability of the support for the PS voice service with respect to the one or more areas as indicated by the information is at a Public Land Mobile Network (PLMN) level, an Access and Mobility Management Function (AMF) level, a registration area (RA) level, or a tracking area (TA) level.

16. The method of claim 14, wherein the first mobile communication system comprises a 5^{th}-Generation System (5GS), wherein the second mobile communication system comprises an Evolved Packet System (EPS) or a Universal Mobile Telecommunications System (UMTS), and wherein the PS voice service comprises an Internet Protocol (IP) Multimedia Subsystem (IMS)-supported voice service.

17. The method of claim 14, further comprising:
executing a registration procedure with the second mobile communication system in either a single-registration mode or a dual-registration mode with the UE in a registered state with respect to registration management.

18. A method, comprising:
establishing, by a processor of a user equipment (UE), a connection with a second mobile communication system based on voice domain selection (VDS);
receiving, by the processor, an indication related to support for packet-switched (PS) voice service being available in a first mobile communication system; and
establishing, by the processor, a connection with the first mobile communication system to receive the PS voice service from the first mobile communication system based on the indication.

19. The method of claim 18, wherein the receiving of the indication comprises receiving the indication after a voice call provided by the second mobile communication system for the UE ends or upon availability of the support for the PS voice service in the first mobile communication system, wherein the first mobile communication system comprises a 5^{th}-Generation System (5GS), wherein the second mobile communication system comprises an Evolved Packet System (EPS) or a Universal Mobile Telecommunications System (UMTS), and wherein the PS voice service comprises an Internet Protocol (IP) Multimedia Subsystem (IMS)-supported voice service.

20. The method of claim 18, wherein the indication further comprises information on homogeneousness of support of the PS voice service with respect to the one or more areas, wherein a granularity of the availability of the support for the PS voice service with respect to the one or more areas as stored in the list is at a PLMN level, an Access and Mobility Management Function (AMF) level, a registration area (RA) level, or a tracking area (TA) level.
